SEQUENCE LISTING (1 sequence)

SEQ ID NO: 1 - protein, 640 aa, Artificial Sequence
  Synthetic
MRLSTSSLFLSVSLLGKLALGLSAAEWRTQSIYFLLTDRFGRTDNSTTATCDTGDQIYCGGSWQGIINHLDYIQGMGFTAIWISPITEQLPQDTADGEAYHGYWQQKIYDVNSNFGTADDLKSLSDALHARGMYLMVDVVPNHMGYAGNGNDVDYSVFDPFDSSSYFHPYCLITDWDNLTMVQDCWEGDTIVSLPDLNTTETAVRTIWYDWVADLVSNYSVDGLRIDSVLEVEPDFFPGYQEAAGVYCVGEVDNGNPALDCPYQKVLDGVLNYPIYWQLLYAFESSSGSISNLYNMIKSVASDCSDPTLLGNFIENHDNPRFASYTSDYSQAKNVLSYIFLSDGIPIVYAGEEQHYSGGKVPYNREATWLSGYDTSAELYTWIATTNAIRKLAISADSAYITYANDAFYTDSNTIAMRKGTSGSQVITVLSNKGSSGSSYTLTLSGSGYTSGTKLIEAYTCTSVTVDSSGDIPVPMASGLPRVLLPASVVDSSSLCGGSGRTTTTTTAATSTSKATTSSSSSSAAATTSSSCTATSTTLPITFEELVTTTYGEEVYLSGSISQLGEWDTSDAVKLSADDYTSSNPEWSVTVSLPVGTTFEYKFIKVDEGGSVTWESDPNREYTVPECGNGSGETVVDTWR

(19) United States
(12) Patent Application Publication
(10) Pub. No.: US 2009/0181125 A1
(43) Pub. Date: Jul. 16, 2009

(54) Peanut Oil Production

(75) Inventors: Zhiwei Zhou, Beijing (CN); Hong Zhi Huang, Beijing (CN)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 11/913,421

(22) PCT Filed: Jun. 7, 2006
(86) PCT No.: PCT/DK2006/000315

§ 371 Date: Nov. 2, 2007

Related U.S. Application Data
(60) Provisional application No. 60/689,142, filed on Jun. 9, 2005.

(30) Foreign Application Priority Data
Jun. 8, 2005 (DK) 2005 00838

(51) Int. Cl. A23D 9/007; A23L 1/36; A23D 9/02; C11B 1/04; C11B 1/06; C11B 1/10

(52) U.S. Cl. 426/44; 426/601; 426/632

(57) ABSTRACT

The present invention relates to methods for producing peanut products and to the products of such processes.

### FIELD OF THE INVENTION

The present invention relates to methods for producing peanut products and to the products of such processes.

### BACKGROUND

Peanut oil processed by conventional technology is one of the most popular cooking oil in Southeast Asia especially due to its characteristic aroma. The aroma is a very important quality parameter generally recognized by consumers.

It is an object of the present disclosure to provide methods for production of peanut oil having improved aroma and/or taste.

### SUMMARY OF THE INVENTION

The present invention provides in a first aspect a process for production of a peanut product comprising treating a peanut material with at least one amylolytic enzyme.

In further aspects the invention provides peanut products, e.g. peanut oil or peanut butter, obtainable by the process of the first aspect.

### DETAILED DESCRIPTION OF THE INVENTION

Traditionally, the oil aroma is generated during the treatment of crushed peanut by roasting, where Maillard reaction is thought to be the main mechanism.

Without being bound by theory it is proposed that the beneficial effect of the methods provided herein is due to that precursors for the Maillard reaction, e.g. glucose, are being released in the enzyme treated peanut material and that during a subsequent heating Maillard reactions generate an increased amount of aromatic compounds. The methods provided herein improve the taste and/or colour of the peanut oil. However, the applicability of the methods provided herein is not limited to peanut oil and may be used to improve the aroma, taste and/or colour of any peanut product.

Accordingly the invention relates to a process for production of a peanut product, e.g. peanut oil, and/or peanut butter, comprising treating a peanut material with at least one amylolytic enzyme. The at least one amylolytic enzyme is preferably a glucoamylase or an alpha-amylase or both. In another preferred embodiment the peanut material may in addition to the at least one amylolytic enzyme further be treated with an enzyme selected from the list consisting of; cellulase, protease, xylanase and pectinase.

Before and/or during the enzymatic treatment the peanut material may be subjected to a heat treatment, e.g. comprising heating the peanut material to a temperature of at least 70° C., preferably at least 80° C., more preferably at least 90° C., and most preferably to around 100° C.

In a particularly preferred embodiment of the first aspect the peanut product is peanut oil and the process comprising the steps of: a) treating a peanut material with at least one amylolytic enzyme, and, b) pressing and/or extracting the treated peanut material to produce peanut oil.

The peanut material to be processed by the methods described herein is preferably obtained by subjecting peanuts to a suitable mechanical treatment, e.g. by grinding, resulting in a particle size that enables a sufficient penetration of the enzymes within a suitable reaction time. The skilled person may determine a suitable mechanical treatment on the basis of methods known in the art and considering the intended use of the peanut materiel, e.g. for peanut butter, or for extraction of peanut oil. Preferably the peanut material to be processed to peanut oil is a meal, more preferably a meal with a particle size of 5 mesh to 30 mesh, and more preferably a meal with a particle size from 10 mesh to 20 mesh.

Following the enzymatic treatment of the first aspect (e.g. after step (a) and before, during and/or after step (b) in the above particularly preferred embodiment) the peanut material and/or the peanut oil may be heated to a temperature range sufficiently high to enable Maillard reactions to occur, preferably from 110° C. to 250° C., more preferably from 120° C. to 240° C., most preferably from 130° C. to 230° C., such as from around 140° C. to around 220° C. It may, however, be considered desirable not to induce complete formation of the aromatic Maillard products during the process of the invention as it is then possible to produce a peanut product, e.g. a peanut oil, which only upon being heated by the consumer develops its full aroma.

The above particularly preferred embodiment for production of peanut oil may comprise mechanical and/or hydraulical pressing of the peanut material to obtain peanut oil and/or it may comprise extracting the peanut material with a non-polar solvent, an alcohol and/or water to obtain peanut oil.

The present invention further relates to peanut products, e.g. peanut butter and/or peanut oil, obtainable from the processes described above.

In the methods of the present invention, any enzyme may be used which possesses suitable enzyme activity in an appropriate pH and temperature range. In a preferred embodiment, the enzymes have a pH optimum in the range of about 3 to about 10. In a more preferred embodiment, the enzymes have a pH optimum in the range of about 4.5 to about 8.5.

In another preferred embodiment, the enzymes have a temperature optimum in the range of about 0° C. to about 110° C., more preferably in the range of 20° C. to 100° C., and most preferably in the range of 50° C. to 80° C.

The term “effective amount” is defined herein as an amount of one or more enzymes that is sufficient for providing a measurable effect on at least one property of interest of the product. In this case the property of interest is defined herein as peanut oil colour and/or aroma and/or taste and/or yield.

The source of the enzymes is not critical for use in the methods of the present invention for improving one or more properties of interest of the peanut oil product. Accordingly, the enzymes may be obtained from any source such as a plant, micro organism, or animal. The enzymes are preferably obtained from a microbial source, such as a bacterium or a fungus, e.g., a filamentous fungus or yeast and may be obtained by techniques conventionally used in the art.

In a preferred embodiment, the enzymes are obtained from a fungal source. For example, the enzymes may be obtained from a yeast strain such as a Candida, Kluyveromyces, Pichia, Saccharomyces, Schizosaccharomyces, or Yarrowia strain; or from a filamentous fungal strain such as an Acremonium, Aspergillus, Aureobasidium, Chrysosporium, Cryptococcus, Filibasidium, Fusarium, Humicola, Magnaporthe, Monilia, Mucor, Myceliophthora, Neocallimastix, Neurospora, Paecilomyces, Penicillium, Phanerochaete, Piromyces, Schizophyllum, Sclerotium, Sporotrichum, Talaromyces, Thermoascus, Thielavia, Tolypocladium, or Trichoderma strain.

In another more preferred embodiment, the enzymes are obtained from an Aspergillus aculeatus, Aspergillus awamori, Aspergillus foetidus, Aspergillus japonicus, Aspergillus nidulans, Aspergillus niger, Aspergillus oryzae, Chrysosporium lignorum, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, Fusarium venenatum, Humicola insolens, Humicola lanuginosa, Monilia sitophila, Mucor miehei, Myceliophthora thermophila, Neurospora crassa, Penicillium purpurogenum, Phanerochaete chrysporum, Polyporus pinsitus, Polyporus versicolour, Sclerotium rolfsii, Sporotrichum thermophile, Trichoderma citrinoviride, Trichoderma hamatum, Trichoderma harzianum, Trichoderma koningii, Trichoderma longibrachiatum, Trichoderma polysporum, Trichoderma reesei, Trichoderma saturnisporum, or Trichoderma viride strain.

The enzymes may be obtained from the organism in question by any suitable technique and in particular by use of recombinant DNA techniques known in the art (c.f. Sambrook, J. et al., 1989, Molecular Cloning, A Laboratory Manual, Cold Spring Harbor Press, Cold Spring Harbor, N.Y., USA). The use of recombinant DNA techniques generally comprises cultivation of a host cell transformed with a recombinant DNA vector, consisting of the product gene of interest inserted between an appropriate promoter and terminator, in a culture medium under conditions permitting the expression of the enzyme and recovering the enzyme from the culture. The DNA sequence may be of genomic, cDNA or synthetic origin or any mixture of these, and may be isolated or synthesized in accordance with methods known in the art. The enzyme may also be obtained from its naturally occurring source, such as a plant or organism, or relevant part thereof.

An alpha-amylase to be used in the processes of the invention may be derived from a microorganism or a plant, preferably from a fungal or bacterial source. In a preferred embodiment, the alpha-amylase is a fungal alpha-amylase or an acid fungal alpha-amylase. Preferably the acid fungal alpha-amylase is obtained from a strain of Aspergillus, preferably a strain of Aspergillus niger, a strain of Aspergillus kawachii or a strain of a strain of Aspergillus oryzae. More preferably the acid alpha-amylase is an acid alpha-amylase having at least 70% homology, such as at least 80% or even at least 90% homology to the acid fungal alpha-amylase having the amino acid sequence |SWISSPROT No: P56271| or having at least 70% homology, such as at least 80% or even at least 90% homology to the acid fungal alpha-amylase having the amino acid in the sequence |SWISPROT No: P10529|. Even more preferred for the present invention is an alpha-amylase having a starch binding domain (carbohydrate-binding module) as defined in WO 2005/003311, e.g. such as the alpha-amylase disclosed herein as SEQ ID NO:1.

Preferred commercial compositions comprising alpha-amylase include Mycolase from DSM (Gist Brochades), BAN™, TERMAMYL™ SC, FUNGAMYL™, LIQUOZYME™ X and SAN™ SUPER, SAN™ EXTRA L (Novozymes A/S) and Clarase L-40,000, DEX-LO™, Spezyme FRED, SPEZYME™ AA, and SPEZYME™ DELTA M (Genencor Int.).

A glucoamylase (E.C.3.2.1.3) to be used in the processes of the invention may be derived from a microorganism or a plant. Preferred is glucoamylases of fungal origin such as Aspergillus glucoamylases, in particular A. niger G1 or G2 glucoamylase (Boel et al. (1984), EMBO J. 3 (5), p. 1097-1102). Also preferred are variants thereof, such as disclosed in WO92/00381 and WO00/04136; the A. awamori glucoamylase (WO84/02921), A. oryzae (Agric. Biol. Chem. (1991), 55 (4), p. 941-949), or variants or fragments thereof. Preferred glucoamylases include the glucoamylases derived from Aspergillus niger, such as a glucoamylase having at least 70%, 75%, 80%, 85% or even at least 90% homology to the amino acid sequence set forth in WO00/04136 and SEQ ID NO: 13. Also preferred are the glucoamylases derived from Aspergillus oryzae, such as a glucoamylase having at least 70%, 75%, 80%, 85% or even at least 90% homology to the amino acid sequence set forth in WO00/04136 SEQ ID NO:2.

Other preferred glucoamylases include Talaromyces glucoamylases, in particular derived from Talaromyces emersonii (WO99/28448), Talaromyces leycettanus (U.S. Pat. No. Re. 32,153), Talaromyces duponti, Talaromyces thermophilus (U.S. Pat. No. 4,587,215), Clostridium, in particular C. thermoamylolyticum (EP135,138), and C. thermohydrosulfuricum (WO86/01831).

Commercially available compositions comprising glucoamylase include AMG 200L; AMG 300 L; SAN™ SUPER, SAN EXTRA L and AMG™ E (from Novozymes A/S); OPTIDEX™ 300 (from Genencor Int.); AMIGASE™ and AMIGASE™ PLUS (from DSM); G-ZYME™ G900, G-ZYME™ and G990 ZR (from Genencor Int.).

The treatment of the peanut material with the one or more enzymes necessarily involves contacting the peanut material with the enzyme(s) under suitable conditions. Accordingly, the enzyme treatment may be performed by contacting the crushed peanut with the one or more enzymes comprised in an enzyme composition. The enzyme composition may comprise one or more single enzyme components, one or more multi-component enzyme compositions, or a mixture of one or more single enzyme components and one or more multi-component enzyme compositions.

The enzymes to be used in the methods of the present invention may be in any form suitable for the use in question, e.g., in the form of a dry powder, agglomerated powder, or granulate, in particular a non-dusting granulate, a liquid, in particular a stabilized liquid, or a protected enzyme. The enzymes may be diluted and/or dissolved in an appropriate solvent, preferably water, before being applied to the peanut material.

In terms of enzyme activity, the appropriate dosage of a given enzyme will depend on the enzyme in question. The skilled person may determine a suitable enzyme unit dosage on the basis of methods known in the art.

In the methods of the present invention the effective amount of the enzyme is about 0.001 g to about 200 g enzyme protein per kg peanut material, more preferably about 0.01 g to about 20 g per kg peanut material, even more preferably about 0.1 g to about 10 g per kg peanut material, and most preferably about 5 g per kg peanut material.

It is understood that any of the embodiments described herein may be combined to produce a more aromatic peanut oil product.

The present invention is further described by the following examples that should not be construed as limiting the scope of the invention.

### Materials and Methods

### Alpha-Amylase Activity (KNU)

The amylolytic activity may be determined using potato starch as substrate. This method is based on the break-down of modified potato starch by the enzyme, and the reaction is followed by mixing samples of the starch/enzyme solution with an iodine solution. Initially, a blackish-blue color is formed, but during the break-down of the starch the blue color gets weaker and gradually turns into a reddish-brown, which is compared to a colored glass standard.

One Kilo Novo alpha amylase Unit (KNU) is defined as the amount of enzyme which, under standard conditions (i.e. at 37° C. +/−0.05; 0.0003 M Ca²⁺; and pH 5.6) dextrinizes 5260 mg starch dry substance Merck Amylum solubile.

A folder EB-SM-0009.02/01 describing this analytical method in more detail is available upon request to Novozymes A/S, Denmark, which folder is hereby included by reference.

### Acid Alpha-Amylase Activity (AFAU)

Acid alpha-amylase activity may be measured in AFAU (Acid Fungal Alpha-amylase Units), which are determined relative to an enzyme standard. 1 FAU is defined as the amount of enzyme which degrades 5260 mg starch dry matter per hour under the below mentioned standard conditions.

Acid alpha-amylase, an endo-alpha-amylase (1,4-alpha-D-glucan-glucanohydrolase, E.C. 3.2.1.1) hydrolyzes alpha-1,4-glucosidic bonds in the inner regions of the starch molecule to form dextrins and oligosaccharides with different chain lengths. The intensity of color formed with iodine is directly proportional to the concentration of starch. Amylase activity is determined using reverse colorimetry as a reduction in the concentration of starch under the specified analytical conditions.

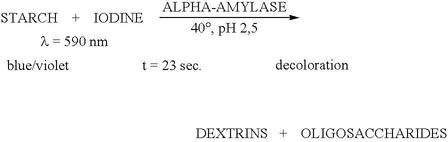

Standard conditions/reaction conditions:

| | |
|---|---|
| Substrate: | Soluble starch, approx. 0.17 g/L |
| Buffer: | Citrate, approx. 0.03 M |
| Iodine (I2): | 0.03 g/L |
| CaCl2: | 1.85 mM |
| pH: | 2.50 ± 0.05 |
| Incubation temperature: | 40° C. |
| Reaction time: | 23 seconds |
| Wavelength: | 590 nm |
| Enzyme concentration: | 0.025 AFAU/mL |
| Enzyme working range: | 0.01-0.04 AFAU/mL |

A folder EB-SM-0259.02/01 describing this analytical method in more detail is available upon request to Novozymes A/S, Denmark, which folder is hereby included by reference.

### Glucoamylase Activity (AGU)

Glucoamylase activity may be measured in AmyloGlucosidase Units (AGU). One AGU is defined as the amount of enzyme, which hydrolyzes 1 micromole maltose per minute under the standard conditions 37° C., pH 4.3, substrate: maltose 23.2 mM, buffer: acetate 0.1 M, reaction time: 5 minutes.

An autoanalyzer system may be used. Mutarotase is added to the glucose dehydrogenase reagent so that any alpha-D-glucose present is turned into beta-D-glucose. Glucose dehydrogenase reacts specifically with beta-D-glucose in the reaction mentioned above, forming NADH which is determined using a photometer at 340 nm as a measure of the original glucose concentration.

AMG incubation:

| | |
|---|---|
| Substrate: | maltose 23.2 mM |
| Buffer: | acetate 0.1 M |
| pH: | 4.30 ± 0.05 |
| Incubation temperature: | 37° C. ± 1 |
| Reaction time: | 5 minutes |
| Enzyme working range: | 0.5-4.0 AGU/mL |

Color reaction:

| | |
|---|---|
| GlucDH: | 430 U/L |
| Mutarotase: | 9 U/L |
| NAD: | 0.21 mM |
| Buffer: | phosphate 0.12 M; 0.15 M NaCl |
| pH: | 7.60 ± 0.05 |
| Incubation temperature: | 37° C. ± 1 |
| Reaction time: | 5 minutes |
| Wavelength: | 340 nm |

A folder (EB-SM-0131.02/01) describing this analytical method in more detail is available on request from Novozymes A/S, Denmark, which folder is hereby included by reference.

### Enzymes

The enzyme compositions used were an Aspergillus niger glucoamylase compositions with 400 AGU/ml and a compositions 160 comprising AFAU/ml of a fungal alpha-amylase having the sequence shown herein as SEQ ID NO:1.

### EXAMPLE 1

Peanuts were crushed into a meal with average particle size from 10 mesh to 20 mesh. Samples of 10 g peanut meal were mixed with 1 ml enzyme solution (0.01% to 0.5% glucoamylase or alpha-amylase composition). The samples were incubated at 50° C. for 4 hours and dried at 180° C. for 30 min. The dried samples were scored on a 1-4 colour scale, 4 being the darkest (Table 1) and on a 1-4 aroma scale, 4 being the most aromatic (Table 2). A sensory panel with 5 experienced members evaluated the aroma of the dried samples in a blind test. Correlation between enzyme dosage and colour/aroma was observed.

TABLE 1
Score of colour of dried peanut meal

| | Enzyme dosage | | | | |
|---|---|---|---|---|---|
| | 0 | 0.01% | 0.05% | 0.1% | 0.5% |
| Glucoamylase | 2 | 2 | 2 | 3 | 4 |
| Alpha-amylase | 2 | 2 | 3 | 3 | 4 |

TABLE 2
Score of aroma of dried peanut meal

| | Enzyme dosage | | | | |
|---|---|---|---|---|---|
| | 0 | 0.01% | 0.05% | 0.1% | 0.5% |
| Glucoamylase | 2 | 2 | 2 | 3 | 4 |
| Alpha-amylase | 2 | 2 | 3 | 3 | 4 |

### EXAMPLE 2

Peanuts were crushed into a meal with average particle size from 10 mesh to 20 mesh. To an 8 kg sample of peanut meal, 720 ml water and 80 ml glucoamylase composition were added. The mixture was incubated at 50° C. for 4 hours. The peanut meal was dried at 220° C. for 20 min and hydraulically pressed to produce oil. A blank sample without glucoamylase was treated by the same procedure.

A sensory panel with 5 experienced members evaluated the aroma of the peanut oil in a blind test, and the entire panel found that the enzyme treated peanut oil was more aromatic than the blank.

1. A process for production of a peanut product comprising treating a peanut material with at least one amylolytic enzyme.

2. The process of claim 1 wherein the peanut product is peanut oil, said process comprising the steps of:
a. treating a peanut material with at least one amylolytic enzyme, and,
b. pressing and/or extracting the treated peanut material to produce peanut oil.

3. The process of claim 1 wherein the at least one amylolytic enzyme is a glucoamylase and/or an alpha-amylase.

4. The process of claim 1 further comprising treating the peanut material with an enzyme selected from the list consisting of; cellulase, protease, xylanase and pectinase.

5. The process of claim 1 further comprising, before and/or during the enzymatic treatment, heating the peanut material to a temperature of at least 70° C.

6. The process of claim 1 further comprising after the enzymatic treatment (e.g. before, during and/or after step (b)) heating the peanut material and/or the peanut oil to a temperature sufficiently high to enable Maillard reactions to occur.

7. The process of claim 1 wherein the peanut material is a peanut meal, preferably a peanut meal having a particle size between 5 mesh and 30 mesh.

8. The process of claim 1 wherein step (b) comprises mechanical and/or hydraulical pressing of the peanut material to obtain peanut oil.

9. The process of claim 1 wherein step (b) comprises extracting the peanut material with a non-polar solvent, an alcohol and/or water to obtain peanut oil.

10. A peanut product obtainable by the processes of claim 1.

11. A peanut oil obtainable by the processes of claim 2.

12. The process of claim 1 further comprising, before and/or during the enzymatic treatment, heating the peanut material to a temperature of at least 80° C.

13. The process of claim 1 further comprising, before and/or during the enzymatic treatment, heating the peanut material to a temperature of at least 90° C.

14. The process of claim 1 further comprising, before and/or during the enzymatic treatment, heating the peanut material to a temperature of at least 100° C.
